(19) United States
(12) Patent Application Publication
(10) Pub. No.: US 2023/0270278 A1
(43) Pub. Date: Aug. 31, 2023

(54) FLUIDICALLY PRECONDITIONING BEVERAGE INGREDIENT PORTIONS

(71) Applicant: SOCIETE DES PRODUITS NESTLE S.A., Vevey (CH)

(72) Inventors: YAN DUPASQUIER, Romont (CH); GILLES GAVILLET, Ursy (CH); RENZO MOSER, Gummenen (CH); CHRISTIAN THOMAS, Boll (CH)

(21) Appl. No.: 18/006,599

(22) PCT Filed: Jul. 23, 2021
(86) PCT No.: PCT/EP2021/070636

§ 371 Date: Jan. 24, 2023

(30) Foreign Application Priority Data
Jul. 24, 2020 (EP) 20187592.9

(51) Int. Cl. A47J 31/40; A47J 31/36

(52) U.S. Cl. CPC A47J 31/405; A47J 31/3614; A47J 31/3619

(57) ABSTRACT

A machine (1) for serving a beverage (7) via a dispensing outlet (8) to a consumer receptacle (9) by mixing water (3) from a water source (3′) with a flavouring ingredient (2), has a mixing unit (10) that comprises: a stationary support (11); a seat (12) having an ingredient opening (120); a closure part (13) configured to close and open the ingredient opening (120); and a wall part (14) that is movable inside the seat (12). The seat (12), the closure part (13) and the wall part (14) are: mounted to the support (11); and relatively movable between a transfer configuration and a mixing chamber configuration in which the seat (12) and the closure part (13) and the wall part (14) form a mixing chamber (12′) fluidically connected with the water source (3′). The machine (1) has a control unit (C) that is configured to control a preconditioning of the flavouring ingredient after an introduction into the seat's ingredient opening (120). The preconditioning of the flavouring ingredient comprises a portion loosening supply of water (3) from the water source (3′) into the mixing chamber (12′).

### FIELD OF THE INVENTION

The field of the invention pertains to beverage preparation and serving machines which typically use thermally conditioned liquid, such as heated and/or cooled liquid. The liquid is typically water or water-based. The liquid may be a carrier and/or a solvent for preparing the beverage. The machine may be configured to prepare the beverage by mixing the liquid with a flavouring ingredient, e.g. a flavouring ingredient supplied in a solid form, of the beverage to be prepared.

The machine may be configured to handle a portioned flavouring ingredient. Therefore, typically a predetermined amount of consumable is preconditioned (e.g. factory preconditioned) prior to introduction into the machine. One or a plurality of such preconditioned amounts of consumable are used for producing a single beverage serving by such machine.

For the purpose of the present description, a “beverage” is meant to include any human-consumable liquid substance, such as tea, coffee, cacao, hot or cold chocolate, milk, soup, baby food, etc.

### BACKGROUND ART

Certain beverage preparation machines use capsules containing ingredients to be extracted or to be dissolved and/or ingredients that are stored and dosed automatically in the machine or else are added at the time of preparation of the drink. Some beverage machines possess filling means that include a pump for liquid, usually water, which pumps the liquid from a source of water that is cold or indeed heated through heating means, e.g. a thermoblock or the like.

Especially in the field of coffee preparation, machines have been widely developed in which a capsule containing beverage ingredients is inserted in a brewing device. The brewing device is tightly closed about the capsule, water is injected at the first face of the capsule, the beverage is produced in the closed volume of the capsule and a brewed beverage can be drained from a second face of the capsule and collected into a receptacle such as a cup or glass.

EP2175762 discloses a brewing unit that includes on a support structure a seat with a rotation movement and a piston sliding in the seat as well as a counter-piston, which are movable between a loading configuration. Several brewing configurations for delimiting different brewing chamber volumes and an ejection configuration are disclosed. The brewing unit has a first set of cam profiles fixed to the support structure and a second set of cam profiles rotatable relative to the support structure, so that each movement of the seat, of the piston and of the counter-piston is controlled by the fixed cam profiles and by the movable cam profiles.

### SUMMARY OF THE INVENTION

The invention relates to a machine for preparing a beverage from at least one ingredient. Normally such beverage is then dispensed to a user, e.g. to a user-cup or user-mug.

The beverage preparation typically includes the mixing of a plurality of beverage ingredients for dissolution and/or dispersion, e.g. water and at least one of milk powder and sugar and instant coffee and instant tea and instant chocolate and instant soup, and/or the infusion of a beverage ingredient, such as an infusion of ground coffee or tea with water. For instance, a predetermined amount of beverage is formed and dispensed on user-request, which corresponds to a serving. The volume of such a serving may be in the range of 15 to 1000 ml such as 25 to 600 ml for instance 40 to 250 ml, e.g. the volume for filling a cup or mug, depending on the type of beverage. Formed and dispensed beverages may be selected from ristrettos, espressos, lungos, cappuccinos, café latte, americano coffees, teas, etc. . . . . For example, a coffee machine may be configured for dispensing espressos, e.g. an adjustable volume of 20 to 60 ml per serving, and/or for dispensing lungos, e.g. a volume in the range of 60 to 200 ml per serving, and/or for dispensing americanos, e.g. a volume in the range of 150 to 750 ml.

The machine of the invention is configured for handling a flavouring ingredient and preparing a beverage therefrom and serving such beverage via a dispensing outlet to a consumer receptacle, e.g. placed on a support. The beverage may be prepared by mixing the flavouring ingredient, e.g. by infusion and/or brewing, with water from a water source, e.g. a water tank and/or a connector to a water distribution network, for instance via a liquid driver, such as a pump, and/or via a thermal conditioner, e.g. a water heater and/or a cooler.

The thermal conditioner may have a thermal power in the range of 300 to 3000 watt, for instance of 500 to 2300 watt, such as of 700 to 1800 watt, e.g. of 950 to 1500 watt.

The machine has a mixing unit that comprises a support, such as a frame and/or housing, that is stationary during the handling of the flavouring ingredient and optionally during beverage preparation and/or beverage serving.

The mixing unit includes a seat, such as a seat delimiting a substantially prismatic or cylindrical inner shape having a base that is for instance substantially circular or elliptic or ovoidal or polygonal. The seat has an ingredient opening, such as an ingredient opening configured to receive the flavouring ingredient unwrapped before mixing with the water.

The flavouring ingredient supplied into the ingredient opening may be in the shape of at least one solid portion of a self-supporting agglomerate of such flavouring ingredient, such as one solid portion or a discrete number of solid portions, e.g. 2 or 3 or 4 or 5 or 6 portions.

The flavouring ingredient may be supplied within a wrapping or without such wrapping into the machine. The ingredient may be supplied within the wrapping into the machine and then separated from the wrapping prior to mixing the flavouring ingredient with water, for example prior to its introduction into the ingredient opening. Examples of wrapped flavouring ingredients that can be unwrapped by the machine prior to mixing with water are disclosed in WO2019/219523 and EP2019217270.8.

The solid portion can have a rollable shape, e.g. a substantially spherical or ellipsoidal or cylindrical shape or a combination of parts of such shapes, with: a maximum dimension in the range of 15 to 35 mm such as 17.5 to 30 mm e.g. 20 to 27 mm; and/or a maximum dimension in the range of 10 to 90%, for instance 25 to 75% such as 40 to 65% e.g. 51 to 60%, of a maximum dimension of the base of the seat's inner shape.

The flavouring ingredient forming the solid portion can be for instance selected from ground coffee, tea, cacao and chocolate, such as 4 to 12 g ground coffee e.g. to 9 g ground coffee.

The solid portion may be configured to resist a compression force of at least 20 N such as at least 30, e.g. at least 40 N.

The solid portion may be configured to be crushed under a compression force of at most 150 N, for instance at most 135 N, such as at most 120 N, e.g. at most 115 N.

Such compression force necessary and sufficient for crushing the solid portion can be measured when the solid portion is squeezed between two parallel plates with the compression force applied to the plates.

The mixing unit has a closure part configured to close and open the ingredient opening, such as a closure part configured to form a lid on the opening.

The mixing unit includes a wall part that is movable inside the seat. For instance, the wall part is formed by a piston.

The wall part may be movable inside the seat by a wall part actuator, e.g. a motor.

The wall part can be dimensioned to be in sliding contact along and over inner boundaries of the inner shape of the seat at a seal that is stationary relative to the wall part and that seals the wall part against the inner shape.

The seat, the closure part and the wall part are directly or indirectly mounted to the support, e.g. the wall part being carried by the seat and/or the wall part actuator (when present) being directly or indirectly fixed to the seat.

The seat, the closure part and the wall part are relatively movable between:
a transfer configuration for supplying the flavouring ingredient into the seat and/or removing such ingredient upon beverage preparation; and
a mixing chamber configuration in which the seat and the closure part and the wall part form a mixing chamber fluidically connected with the water source.

During beverage preparation the flavouring ingredient is mixed with the water in the mixing chamber to form the beverage prior to serving such beverage via the dispensing outlet.

The machine includes a control unit (e.g. as discussed below), such as a unit comprising at least one of: a controller; a processor; a printed circuit board; a memory; a user-interface; and a power manager. The control unit may be completely incorporated into the machine or may be at least partly deported into a distant device via a communication channel, e.g. a wired and/or wireless network, for instance including one or more of computers and mobile devices, e.g. smart phones or tablets. The control unit may be used for carrying out user-requested processes (e.g. beverage preparation and dispensing) and/or service processes (e.g. cleaning and/or rinsing processes and/or maintenance processes and/or management of flavouring ingredient and/or water).

The seat may be moved relatively to the support by a seat actuator, such as a motor, that is fixed to the support or to the seat.

The seat actuator may relatively move the seat and the support via a transmission. The transmission may include at least one of: gears, such as wheels, e.g. toothed wheels, and/or worms; levers (e.g. levers connected by a knuckle joint); belts such as toothed belts; and racks such as toothed racks.

The seat actuator may be different to the abovementioned wall part actuator and/or different to a remover actuator (e.g. as discussed below).

The closure part may be fixed relative to the support and the seat may be movable: against the closure part so as to close the ingredient opening by the closure part; and away from the closure part so as to open the ingredient opening.

The closure part can be configured to cover a rim of the ingredient opening and/or to remain substantially outside the seat, when the seat is closed by the closure part.

The wall part and/or the abovementioned wall part actuator (when present) can be mounted to follow movements of the seat.

The mixing chamber may be associated with an inlet guide and an outlet guide. The inlet guide can be located in the closure part and the outlet guide can be located in the wall part or vice versa. Both inlet and outlet guides can be located in the closure part or in the wall part.

The outlet guide may be made of a flexible and/or rigid guide and/or associated with a filter. The inlet guide may be associated with a water distributor, e.g. a water shower.

The control unit is configured to control a preconditioning of the flavouring ingredient after an introduction into the seat's ingredient opening in the transfer configuration of at least one solid portion of a self-supporting agglomerate of the flavouring ingredient and subsequent relative movement from the transfer configuration into the mixing chamber configuration and prior to serving the beverage via the dispensing outlet.

One or more solid portions may be introduced into the ingredient opening prior to the preconditioning, each portion having a rollable shape, e.g. a substantially spherical or ellipsoidal or cylindrical shape or a combination of parts of such shapes, with: a maximum dimension in the range of 15 to 35 mm such as 17.5 to 30 mm e.g. 20 to 27 mm; and/or a maximum dimension in the range of 10 to 90%, for instance 25 to 75% such as 40 to 65% e.g. 51 to 60%, of a maximum dimension of the abovementioned base of the seat's inner shape.

The preconditioning of the flavouring ingredient includes a portion loosening supply of water from a or the abovementioned water source into the mixing chamber, such as by controlling a or the abovementioned liquid driver and optionally a or the abovementioned thermal conditioner. Such a preconditioning may involve a prewetting of the flavouring ingredient, e.g. of coffee or tea.

The preconditioning of the flavouring ingredient can include a portion break-up relative movement of the seat and the closure part and the wall part, such as by controlling the abovementioned or one or more actuators, e.g. motors, associated therewith.

The control unit, to control the preconditioning of the flavouring ingredient, may control the abovementioned liquid driver and optionally the abovementioned thermal conditioner e.g. for thermal conditioning to a temperature corresponding substantially to a water temperature during beverage preparation and serving of the beverage via the dispensing outlet, to supply the portion loosening supply of water into the mixing chamber and then to interrupt the supply of water for a period of time, such as for 1 to 120 sec. for instance 5 to 60 sec. e.g. 10 to 30 sec. and/or at a pressure in the chamber that is substantially constant, prior to serving the beverage.

The control unit can be configured to control the supply into the mixing chamber of the abovementioned portion loosening supply of water:
after and/or before carrying out said portion break-up relative movement of the seat and the closure part and the wall part; and/or
in a volume that is in a range of 3 to 85%, such as 5 to 50%, e.g. 10 to 25%, of a total volume of the mixing chamber at a spacing of the closure and wall parts when the beverage is prepared and served via the dispensing outlet; and/or
at a or the abovementioned pressure in the mixing chamber that is in a range of 0.1 to 30 bar above ambient pressure, such as 0.5 to 25 bar above ambient pressure, for instance 1 to 20 bar above ambient pressure, e.g. 2.5 to 16 bar or 4 to 13 bar above ambient pressure; and/or
while closing said outlet guide with an outlet valve, such as: a resilient valve, e.g. a check-valve; and/or a valve controlled by the control unit, e.g. a solenoid valve and/or a pinch valve.

The control unit can be configured to control via the abovementioned at least one actuator the abovementioned break-up relative movement between the wall part and the closure part so as to exercise a compression force onto the solid portion(s) between the closure and wall parts to break-up the solid portion(s).

The agglomerate flavouring ingredient may be selected from ground coffee, tea, cacao and chocolate, such as 4 to 12 g ground coffee e.g. 5 to 9 g ground coffee.

The control unit and the abovementioned at least one actuator can be configured such that the compression force is of at least 20 N, such as at least 30 N, for instance at least 40 N, optionally the compression force being of at most 200 N, such as at most 175 N, for instance at most 150 N, e.g. at most 125 N.

The control unit may be configured to control the break-up relative movement between the wall part and the closure part such that the closure and wall parts are relatively moved to one another between a break-up starting spacing at which the compression force is generated and a mixing spacing at which the flavouring ingredient is mixed with the water. The mixing spacing and the break-up starting spacing can have a ratio in the range of 0.1 to 0.8 such as 0.2 to 0.4. The machine may have a sensor arrangement connected to the control unit for sensing the break-up starting spacing, the control unit being configured to determine the mixing spacing from the sensed break-up starting spacing and/or from monitoring an evolution of a required compression force when the closure and wall parts are relatively moved to one another between the break-up starting spacing and the mixing spacing. The sensor arrangement may be configured to determine at least one of: a power consumption of the at least one actuator e.g. by measuring an electric current and/or voltage consumed by such actuator(s); and a volume and/or weight and/or number of portions supplied into ingredient opening for a serving of the beverage via the dispensing outlet.

The seat can be configured to move relatively to the support according to simultaneous and/or successive geometric translation and geometric rotation.

The seat may be arranged to move relatively to the support: by geometric translation without rotation into and out of the mixing chamber configuration and/or into and out of the transfer configuration; and/or by simultaneous geometric translation and geometric rotation into and out of the transfer configuration.

The seat can have a first pivot and a second pivot spaced apart from the first pivot.

The seat may be configured such that, to move from the mixing chamber configuration to the transfer configuration, the following sequence is carried out:

In a first step, the first and second pivots move relatively to the support along a single straight direction or along parallel directions to move out of the mixing chamber configuration.

Then, in a second step, the first and second pivots move simultaneously along first and second directions, respectively, whereby either the first and the second directions are at an angle, such as an angle in the range of 5 to 175 deg., for instance 45 to 135 deg. e.g. 75 to 105 deg., or the first and the second directions are parallel and the first and second pivots move at different respective speeds, such that the first and second pivots and the seat all simultaneously translate and rotate. For example, the abovementioned single straight direction or parallel directions of the first step are equal to or parallel to at least one of the first and second directions and, optionally, the pivot moving therealong moving backwards while the other pivot moves along its corresponding movement direction during the second step.

By completion of the second step, the first and second pivots have reached the transfer configuration or an intermediate configuration from which, in a third step, the first and second pivots and the seat are translated without rotation into the transfer configuration.

The mixing unit can include the abovementioned wall part actuator that is connected to the wall part by a wall part transmission. Such transmission may comprise one or more of: gears e.g. toothed gears for instance wheels and/or worms; belts e.g. toothed belts and/or belts associated with tensing pulleys; and racks, e.g. toothed racks.

The transmission may include at least one linear drive, such as first and second linear drives arranged in parallel on opposite sides of the wall part e.g. both operated by the wall part actuator.

The first and second linear drives may be both operated by a same output axis of a single motor that forms the wall part actuator e.g. via a mechanical drive divider. For example, the divider includes at least one of gears and belts connecting each of the first and second linear drives with the output axis.

The abovementioned at least one linear drive can have a threaded axle cooperating with a connector device, such as one or more nuts and/or rods and/or wheels, for relative motion. For instance, such a connector device is at the wall part (at or adjacent an output of the transmission) and the threaded axle may be at the wall part actuator (at or adjacent an input of the transmission), or vice versa.

The threaded axle can have a variable pitch to increase a force transmission to the wall part at an end of course movement, e.g. to compact and/or crush the flavouring ingredient in the mixing chamber, and to increase a velocity transmission off such end of course movement.

The support and the seat can be connected by a guide-rail arrangement, e.g. an arrangement comprising at least one of elongated grooves and elongated protrusions and elongated openings, that is stationary relative to the support and a guide-rail counter-member arrangement, e.g. an arrangement comprising at least one of guide pins and guide bolts and guide rollers, that is stationary relative to the seat, or vice versa (such that the guide-rail arrangement is stationary relative to the seat and the guide-rail counter-member arrangement is stationary relative to the support). Such arrangement can be fixed to or integral with the support or with the seat.

The support and the seat may be connected by a pair of mutually facing guide-rail arrangements and guide-rail counter-member arrangements located on opposite sides of the support and the seat.

The counter-member arrangement may form the above-mentioned first and second pivots.

The guide-rail arrangement can have a first guide-rail section and a second guide-rail section that is different to the first guide-rail section. The first and second guide-rail sections may extend along different directions and/or form guiding profiles of different shapes. The guide-rail counter-member arrangement can have a first guide-rail counter-member cooperating with the first guide-rail section and a second guide-rail counter-member cooperating with the second guide-rail section such that the first and second guide-rail sections and the first and second guide-rail counter members cooperate to set together a positioning and orientation of the seat relative to the support. The second guide-rail counter-member and at least a portion of the second guide-rail section may be configured to move relatively to one another along a direction that is non-parallel, e.g. substantially perpendicular, to a direction of simultaneous relative motion of the first guide-rail section and the first guide-rail counter-member.

The second guide-rail counter-member and a further portion of the second guide-rail section can be configured to move relatively to one another along a direction that is parallel to a direction of simultaneous relative motion of the first guide-rail section and the first guide-rail counter-member.

One or more of such sections and such portions may be: straight, curved, or partly straight and partly curved.

The mixing unit may include a waste ingredient remover configured to remove a waste ingredient, for instance a block of waste ingredient e.g. a cake, from the ingredient opening upon beverage preparation and optionally after the waste ingredient having been pushed out of the opening by a corresponding relative movement of the wall part and the seat.

The remover may have at least one of: a drawer-type configuration for being deployed and retracted over the ingredient opening in the transfer configuration; and a front face provided with a recessed part adjacent the ingredient opening in the transfer configuration to guide a supply of the ingredient into the seat in the transfer configuration. Such a recessed part may have at least a part of a substantially cylindrical, conical, domical and/or funnel shape.

The machine can include a waste ingredient collector to which such waste ingredient is evacuated by the remover. For instance, such a collector is formed of a waste ingredient reservoir that is user-removable for emptying and/or servicing e.g. cleaning.

The mixing unit may have a closure seal, such as an elastically deformable seal e.g. a silicon and/or NBR seal, which is located between the closure part and the seat when closed by the seat so that the closure seal is urged between the seat and the closure part in a direction that is substantially parallel to a direction of opening and/or closing the seat by the closure part.

The closure seal may be located along a peripheral part of the ingredient opening, the closure seal being for instance an annular seal.

The closure seal can be compressed along an axial direction of the closure seal, the closure seal being for instance an annular seal.

The closure seal may be fixed to the closure part or to the seat.

The closure part may include a peripheral sealing member, e.g. a member bearing a or the abovementioned closure seal, displaceably mounted on a closure holder and urged away from the holder against the seat, e.g. by a resilient device and/or jack device, while the flavouring ingredient is mixed with the water in the mixing chamber.

The mixing chamber can be entirely enclosed at the ingredient opening by the sealing member and optional closure seal.

The closure part can include a hydraulic chamber for urging the sealing member against the seat, such as a hydraulic chamber sealed by one or more seals extending between the sealing member and the closure holder.

The hydraulic chamber may be fluidically connected to the abovementioned liquid driver for urging water into the hydraulic chamber.

The mixing unit can be configured to guide the urged water from the hydraulic chamber into the mixing chamber e.g. via the abovementioned thermal conditioner.

The mixing chamber may be in fluid communication with a valve configured, e.g. controlled by a or the abovementioned control unit, to release pressure from the mixing chamber when containing the flavouring ingredient prior to driving the water into the mixing chamber for mixing with the flavouring ingredient.

The valve can be assembled to or integral with the seat, the closure part, the wall part, the abovementioned inlet guide or the abovementioned outlet guide.

The valve may be arranged to be open to release air from the chamber when the wall part and the closure part are relatively moved together.

The valve can be arranged to be closed from a beginning of introduction of the water into the mixing chamber containing the ingredient to form the beverage and until serving thereof, for instance until completion of serving thereof.

The invention also relates to a combination of a machine as described above and the above described flavouring ingredient for preparing the beverage in the machine.

Another aspect of the invention relates to a method of handling a flavouring ingredient and preparing a beverage therefrom and serving the beverage via a dispensing outlet to a consumer receptacle. The method includes the steps of: providing a machine as described above; supplying the abovementioned flavouring ingredient into the seat in the transfer configuration; in the mixing chamber configuration, mixing the ingredient with water in the mixing chamber to form the beverage; and serving the beverage via the dispensing outlet.

A further aspect of the invention relates to a use of an ingredient as a flavouring ingredient for: supply to a machine as described above; an implementation of a combination as described above; or an execution of a method as described above.

### BRIEF DESCRIPTION OF THE DRAWINGS

The invention will now be described with reference to the schematic drawings, wherein:

FIG. 1 is a perspective view of part of a machine according to the invention;

FIGS. 2 and 2a are perspective views of a mixing unit in a mixing chamber configuration of the machine of FIG. 1, a lateral support element being hidden in FIG. 2a;

FIGS. 3 and 4 illustrate the mixing unit of FIG. 2a in an intermediate configuration and in a transfer configuration, respectively;

FIGS. 5 and 5a illustrate in perspective cross-section and in longitudinal-section, respectively, the mixing unit of FIG. 2 with three solid portions of flavouring ingredient in the mixing unit's mixing chamber;

FIG. 6 illustrates in perspective cross-section the mixing unit of FIG. 2 with a single solid portion of flavouring ingredient in the mixing unit's mixing chamber;

FIG. 7 illustrates in perspective cross-section the mixing unit of FIGS. 5 and 5a and, schematically, part of flow line associated with the mixing unit, the mixing chamber being at a mixing spacing for three solid portions of flavouring ingredient (the flavouring ingredient being not shown);

FIG. 8 illustrates in perspective cross-section the mixing unit of FIG. 6, the mixing chamber being at a mixing spacing for a single solid portion of flavouring ingredient (the flavouring ingredient being not shown);

FIGS. 9 and 9a illustrate in perspective longitudinal section and in longitudinal section, respectively, the mixing unit of FIG. 7 with three solid portions of flavouring ingredient during mixing of the flavouring ingredient and water;

FIG. 10 illustrates in longitudinal section an intermediate configuration of the brewing unit of the machine of FIG. 1 between the mixing chamber configuration and the transfer configuration after beverage preparation;

FIGS. 11 and 11a illustrate in perspective longitudinal section and in longitudinal section, respectively, the mixing chamber in the transfer configuration after beverage preparation;

FIGS. 12 and 12a illustrate in perspective longitudinal section and in longitudinal section, respectively, the mixing unit in the transfer configuration after waste ingredient has been pushed out of the seat's ingredient opening by the wall part before removal by the waste ingredient remover;

FIGS. 13 and 13a illustrate in perspective longitudinal section and in longitudinal section, respectively, the mixing unit in the transfer configuration after the waste ingredient has been moved away from the seat's ingredient opening by the waste ingredient remover, FIG. 14 being a perspective view of the mixing unit;

FIG. 15 is a perspective view of the mixing unit of the machine shown in FIG. 1 when associated with actuators, e.g. motors, connected to a schematically illustrated control unit arrangement, the mixing unit being in the transfer configuration to receive the flavouring ingredient for preparing a beverage;

FIGS. 16 and 16a are perspective views form above and below, respectively, of an actuator and a transmission of the wall part movable in the seat of the mixing unit of the machine shown in FIG. 1 when associated with the wall part actuator; and

FIG. 17 is a longitudinal-section of the mixing unit of FIG. 1 when fitted with a chamber temperature conditioner.

### DETAILED DESCRIPTION

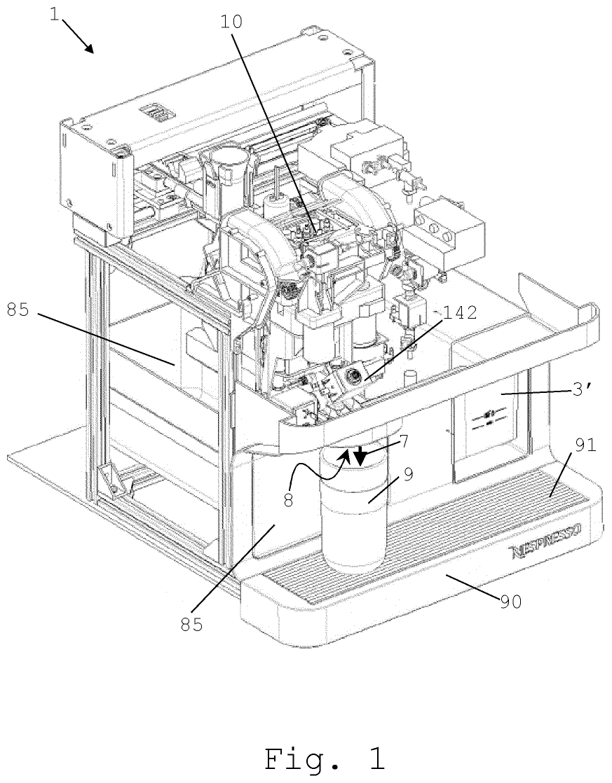

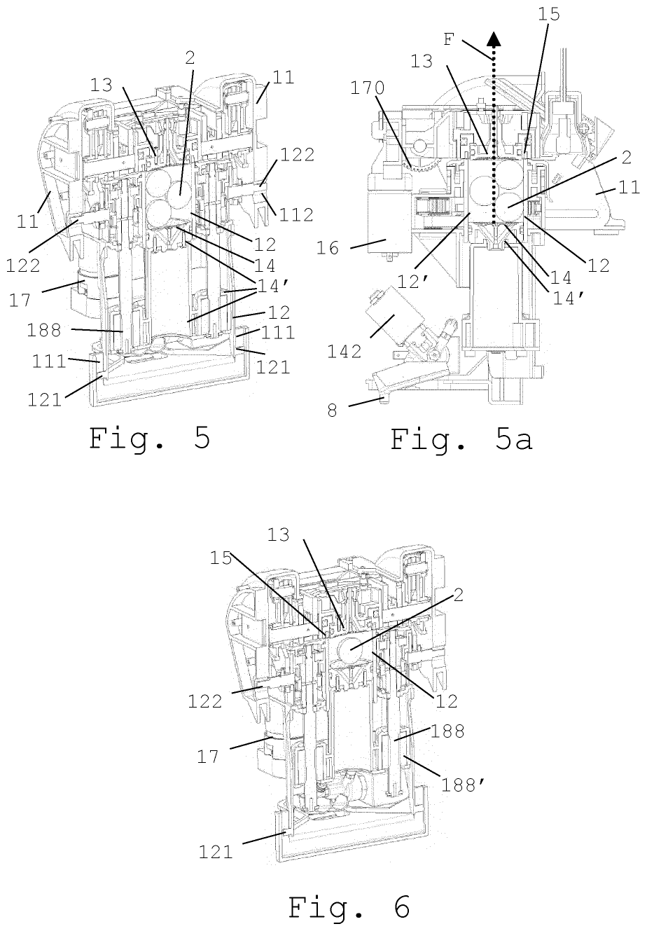

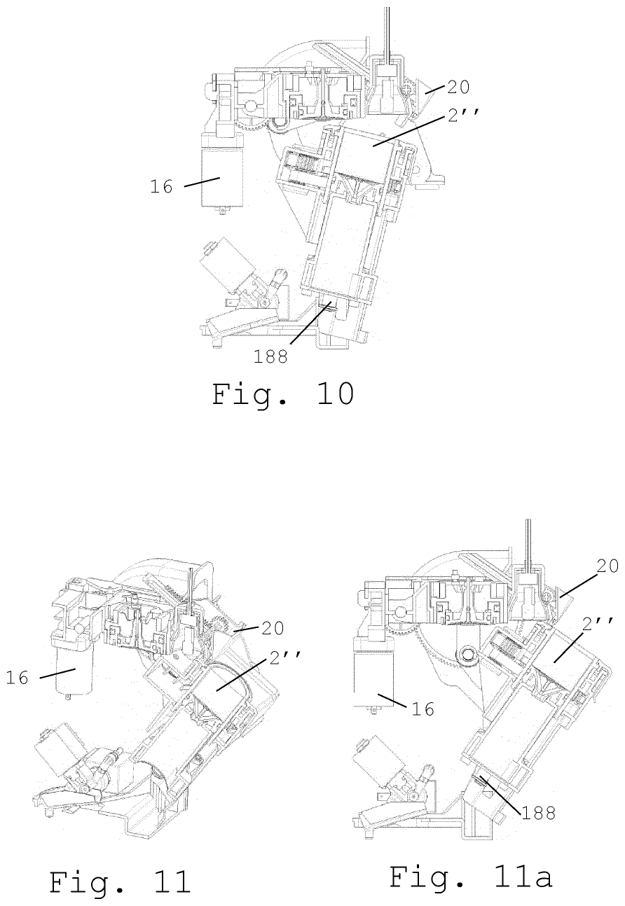

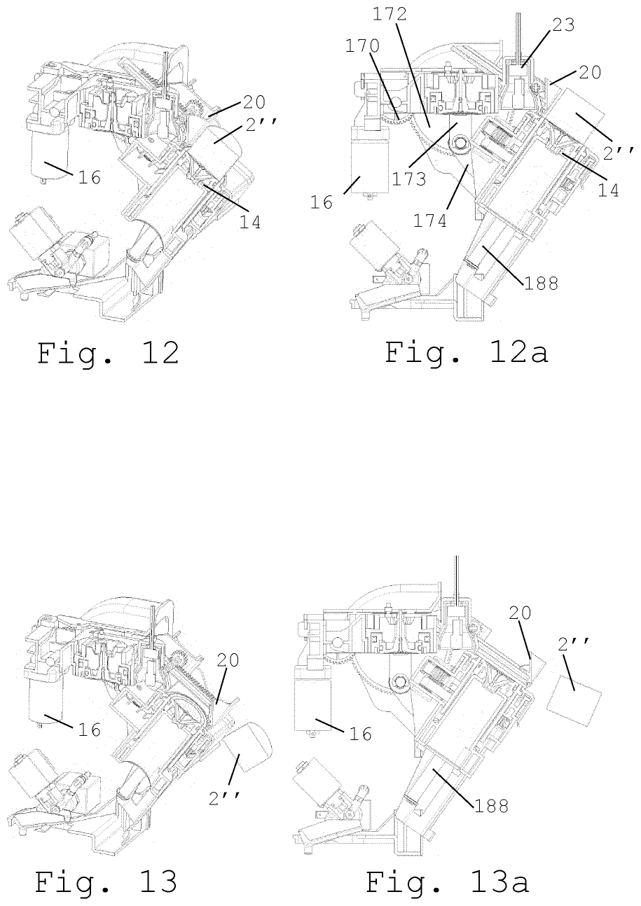

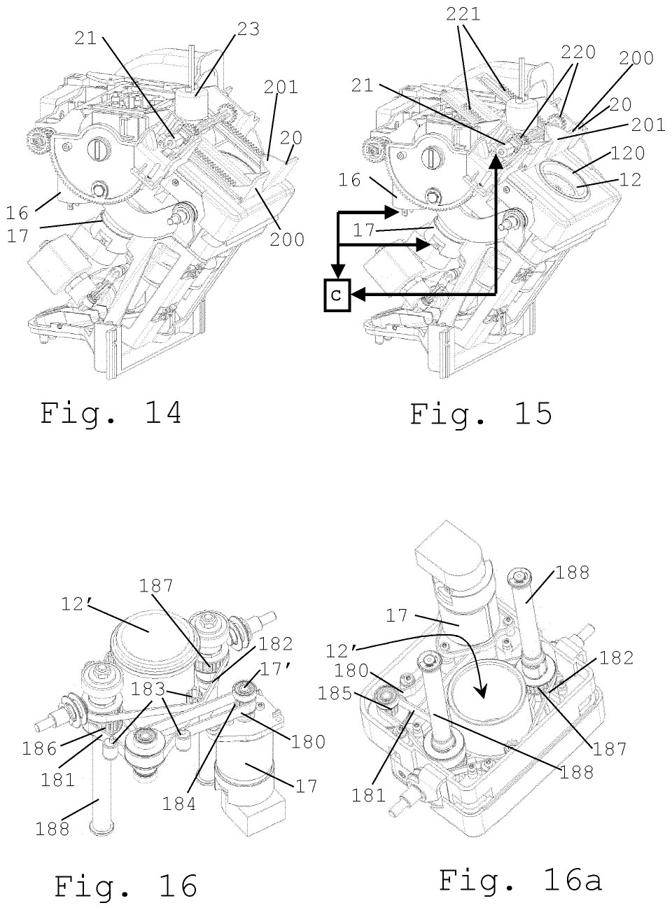

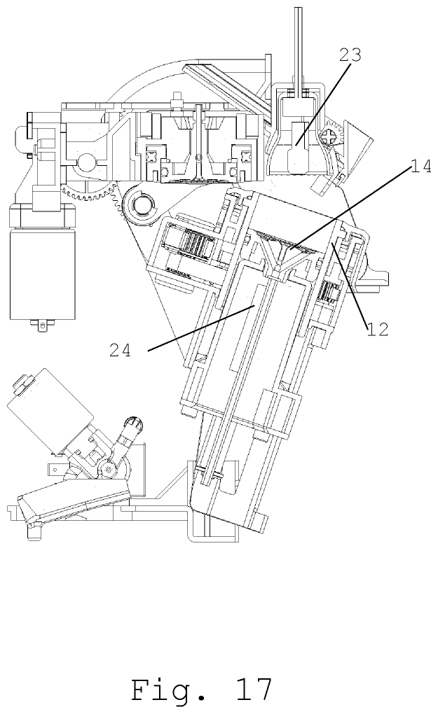

FIGS. 1 to 17 illustrate a non-limiting embodiment of a machine 1 and parts thereof as well as operational sequences according to the invention.

Machine 1 is configured for handling a flavouring ingredient 2 and preparing a beverage 7 therefrom and serving such beverage 7 via a dispensing outlet 8 to a consumer receptacle 9, e.g. a cup and/or a mug.

Machine 1 may be fitted under outlet 8 with a support 90 for such receptacle 9 or may be delimited such that the receptacle can be placed under outlet 8 on a placement surface on which the machine is placed as well. When present, support 90 can be fitted with a drip tray underlying a receptacle support surface 81.

Beverage 7 may be selected from coffee and tea and chocolate and cacao and milk and soup.

Beverage 7 is prepared by mixing water 3 from a water source 3′, e.g. a water tank and/or a connector to a water distribution network, with flavouring ingredient 2, e.g. by infusion. Water 3 may be supplied via a liquid driver 4 such as a pump and/or via a thermal conditioner e.g. a water heater and/or a cooler.

Machine 1 has a mixing unit 10 that includes:
a support 11, such as a frame and/or housing, that is stationary during the handling of flavouring ingredient 2 and optionally during beverage preparation and/or beverage serving;
a seat 12, such as a seat 12 delimiting a substantially prismatic or cylindrical inner shape having a base that is for instance substantially circular or elliptic or ovoidal or polygonal, having an ingredient opening 120, such as an opening 120 configured to receive flavouring ingredient 2 unwrapped before mixing with water 3;
a closure part 13 configured to close and open ingredient opening 120, such as a closure part 13 configured to form a lid on opening 120; and
a wall part 14 that is movable inside seat 12, optionally wall part 14 being at least one of: formed by a piston 14′; driven by a wall part actuator 17 such as a motor; and dimensioned to be in sliding contact along and over inner boundaries of the inner shape of seat 12 at a seal 141 that is stationary relative to wall part 14 and that seals wall part 14 against the inner shape.

Seat 12, closure part 13 and wall part 14 are directly or indirectly mounted to the support 11.

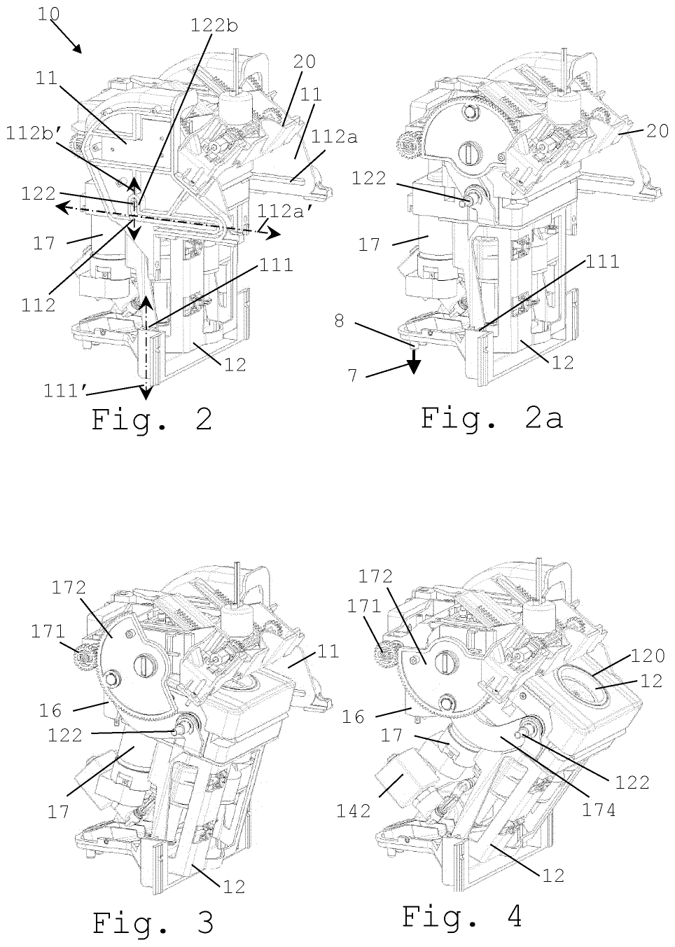

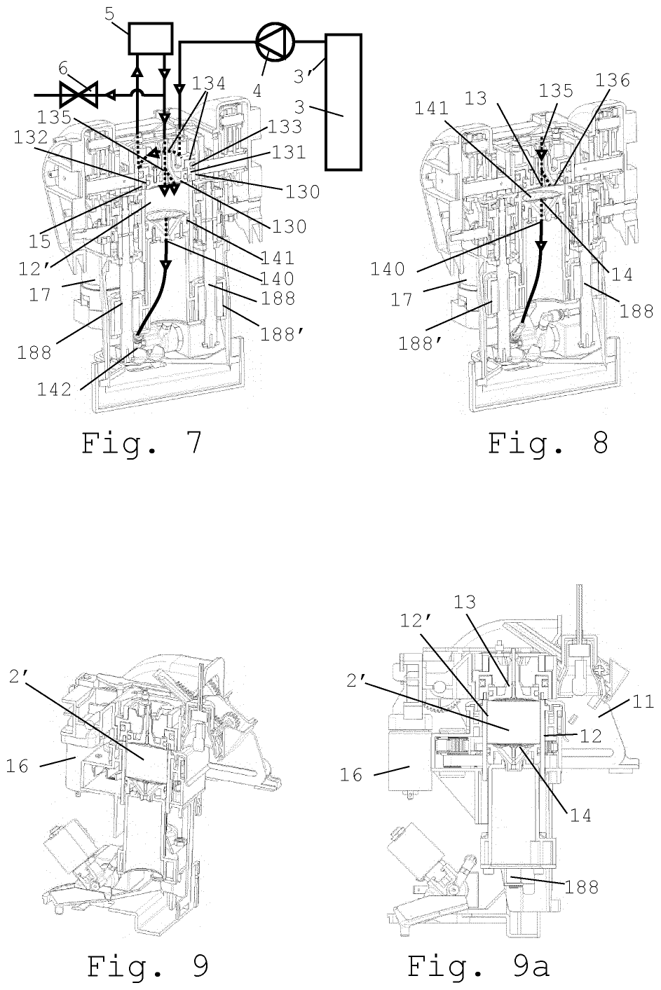

Seat 12, closure part 13 and wall part 14 are relatively movable between: a transfer configuration (e.g. FIG. 4) for supplying flavouring ingredient 2 into seat 12 and/or removing such ingredient 2 upon beverage preparation; and a mixing chamber configuration (e.g. FIGS. 7 and 8) in which seat 12 and closure part 13 and wall part 14 form a mixing chamber 12′ fluidically connected with water source 3′. During beverage preparation flavouring ingredient 2 can be mixed with water 3 in mixing chamber 12′ to form beverage 7 prior to serving such beverage 7 via dispensing outlet 8 (e.g. FIGS. 1 and 2a).

Seat 12 may be moved relatively to support 11 by a seat actuator 16, such as a motor, that is fixed to support 11 or to seat 12. For instance, seat actuator 16 relatively moves support 11 and seat 12 via a transmission 170, 171, 172, 173, 174. Such transmission can include at least one of: gears, such as wheels 170, 171, 172, e.g. toothed wheels, and/or worms; levers 173, 174, e.g. levers connected by a knuckle joint; belts such as toothed belts; and racks, such as toothed racks.

Seat actuator 16 may be different to wall part actuator 17 (when present) and/or different to a remover actuator 21 (e.g. as discussed below).

Closure part 13 may be fixed relative to support 11 and seat 12 may be movable: against closure part 13 such that ingredient opening 120 is closed by closure part 13; and away from closure part 13 such that ingredient opening 120 is opened.

Closure part 13 may be configured to cover a rim of ingredient opening 120 and/or to remain substantially outside seat 12, when seat 12 is closed by closure part 13.

Wall part 14 and/or wall part actuator 17 (when present) may be mounted to follow seat 12, e.g. wall part 14 being carried by seat 12 and/or actuator 17 being directly or indirectly fixed to seat 12.

Machine 1 may include a control unit C (e.g. as discussed below), such as a unit comprising at least one of a controller, processor, printed circuit board, memory, user-interface and power manager.

Mixing chamber 12′ may be associated with an inlet guide 135 and an outlet guide 140. For instance, inlet guide 135 is located in closure part 13 and outlet guide 140 is located in wall part 14 or vice versa, or both inlet and outlet guides are located in the closure part or in the wall part. Outlet guide 140 can be made of a flexible and/or rigid guide and/or associated with a filter 141. Inlet guide 135 may be associated with a water distributor 136, e.g. a water shower.

Seat 12 may be configured to move relatively to support 11 according to simultaneous and/or successive geometric translation and geometric rotation.

Seat 12 can be arranged to move relatively to support 11: by geometric translation without rotation into and out of the mixing chamber configuration and/or into and out of the transfer configuration; and/or by simultaneous geometric translation and geometric rotation into and out of the transfer configuration.

Seat 12 can have a first pivot 121 and a second pivot 122 spaced apart from first pivot 121, seat 12 being configured such that, to move from the mixing chamber configuration to the transfer configuration, the following steps are carried out:

In a first step, first and second pivots 121, 122 move relatively to support 11 along a single straight direction or along parallel directions 111′, 112b′ to move out of the mixing chamber configuration.

Then, in a second step, first and second pivots 121, 122 move simultaneously along first and second directions 112b′, 112a′, respectively. First and second directions 112b′, 112a′ can be at an angle, such as an angle in the range of 5 to 175 deg., for instance 45 to 135 deg. e.g. 75 to 105 deg. Alternatively, the first and second directions may be parallel and the first and second pivots may move at different respective speeds.

Thereby, first and second pivots 121, 122 and seat 12 may all simultaneously translate and rotate. For instance the abovementioned single straight direction or parallel directions 111′, 112b′ of the first step are equal to or parallel to at least one of first and second directions 112b′, 112a′ and optionally pivot 121 moving therealong may move backwards while the other pivot 122 moves along its corresponding movement direction 112a′ during the second step.

By completion of the second step, first and second pivots 121, 122 have reached the transfer configuration or an intermediate configuration. From such an intermediate position, in a third step, the first and second pivots and the seat are translated without rotation into the transfer configuration.

Mixing unit 10 may comprise the abovementioned wall part actuator 17 that is connected to wall part 14 by a wall part transmission 180, 181, 182, 183, 184, 185, 186, 187, 188, 188′. The transmission may include or more of: gears e.g. toothed gears for instance wheels 184, 185, 186, 187 and/or worms; belts 180, 181, 182 e.g. toothed belts and/or belts associated with tensing pulleys 183; and racks, e.g. toothed racks.

The transmission may include at least one linear drive 188, 188′, such as first and second linear drives 188, 188′ arranged in parallel on opposite sides of wall part 14 e.g. both operated by wall part actuator 17.

First and second linear drives 188, 188′ can be both operated by a same output axis 17′ of a single motor that forms wall part actuator 17 e.g. via a mechanical drive divider, such as a divider comprising at least one of gears 184, 185, 186, 187 and belts 180, 181, 182 connecting each of first and second linear drives 188, 188′ with output axis 17′. For instance, divider is achieved by: gears only; or of a combination of gears 184, 185, 186, 187 and belts 180, 181, 182; or of belts only.

At least one linear drive 188, 188′ may have a threaded axle 188 cooperating with a connector device 188′, such as one or more nuts and/or rods and/or wheels, for relative motion.

For example, such connector device 188′ is at wall part 14 (at or adjacent an output of the transmission) and threaded axle 188 is at wall part actuator 17 (at or adjacent an input of the transmission), or vice versa.

Threaded axle 188 may have a variable pitch to increase a force transmission to wall part 14 at an end of course movement, e.g. to compact and/or crush flavouring ingredient 2 in mixing chamber 12′, and to increase a velocity transmission off such end of course movement.

Wall part actuator 17 may have a or the abovementioned output axis 17′ that is parallel or at an angle, e.g. orthogonal, to linear drive(s) 188, 188′.

Support 11 and seat 12 can be connected by a guide-rail arrangement 111, 112, e.g. an arrangement comprising at least one of elongated grooves and elongated protrusions and elongated openings, that is stationary relative to support 11 and a guide-rail counter-member arrangement 121, 122, e.g. an arrangement comprising at least one of guide pins and guide bolts and guide rollers, that is stationary relative to seat 12, or vice versa.

Arrangement 111, 112 can be fixed to or be integral with support 11 or with the seat.

Support 11 and seat 12 may be connected by a pair of mutually facing guide-rail arrangements 111, 112 and guide-rail counter-member arrangements 121, 122 located on opposite sides of support 11 and seat 12.

Counter-member arrangement 121, 122 may form the abovementioned first and second pivots.

Guide-rail arrangement 111, 112 can have a first guide-rail section 111 and a second guide-rail section 112 that is different to first guide-rail section 111. First and second guide-rail sections 111, 112 may extend along different directions and/or form guiding profiles of different shapes. Guide-rail counter-member arrangement 121, 122 can have a first guide-rail counter-member 121 cooperating with first guide-rail section 111 and a second guide-rail counter-member 122 cooperating with second guide-rail section 112 such that first and second guide-rail sections 111, 112 and first and second guide-rail counter members 121, 122 cooperate to set together a positioning and orientation of seat 12 relative to support 11.

Second guide-rail counter-member 122 and at least a portion 112a of second guide-rail section 112 may be configured to move relatively to one another along a direction 112a′ that is non-parallel, e.g. substantially perpendicular, to a direction 111′ of simultaneous relative motion of first guide-rail section 111 and first guide-rail counter-member 121.

Second guide-rail counter-member 122 and a further portion 112b of second guide-rail section 112 can be configured to move relatively to one another along a direction 112b′ that is parallel to a direction 111′ of simultaneous relative motion of first guide-rail section 111 and first guide-rail counter-member 121.

One or more of these sections 111, 112 and portions 112a, 112b can be: straight, curved, or partly straight and partly curved.

Mixing unit 10 may include a waste ingredient remover 20 configured to remove a waste ingredient 2″, for instance a block of waste ingredient e.g. a cake, from ingredient opening 120 upon beverage preparation and optionally after waste ingredient 2″ having been pushed out of opening 120 by a corresponding relative movement of wall part 14 and seat 12.

Remover 20 may have a drawer-type configuration for being deployed and retracted over ingredient opening 120 in the transfer configuration.

Remover 20 can have a front face 200 provided with a recessed part 201 adjacent ingredient opening 120 in the transfer configuration to guide a supply of ingredient 2 into seat 12 in the transfer configuration. For example, recessed part 201 comprises at least a part of a substantially cylindrical, conical, domical and/or funnel shape.

Machine 1 may include a waste ingredient collector 85 to which such waste ingredient 2″ is evacuated by remover 20. For example, collector 85 includes a waste ingredient reservoir that is user-removable for emptying and/or servicing e.g. cleaning.

To remove waste ingredient 2″, remover 20 and seat 12 can be relatively moved when closure part 13 and wall part 14 are in the transfer configuration, such as relatively moved along a plane substantially parallel to a or the abovementioned rim of the ingredient opening 120 e.g. along a straight direction. Unit 10 may incorporate a remover actuator 21, e.g. a motor, to relatively move remover 20 and seat 12 during waste ingredient removal. Remover actuator 21 can be connected to at least one of remover 20 and seat 12 by a transmission, such as a transmission comprising at least one of: gears, for instance wheels 220, e.g. toothed wheels, and/or worms; and racks 221 e.g. toothed racks.

Remover actuator 21 may be fixed to support 11 or to seat 12. For example, remover actuator 21 is different to seat actuator 16 and/or is different to wall part actuator 17 (when such actuator(s) 16, 17 is/are present).

Ingredient opening 120 can have a or the abovementioned rim that extends in the transfer configuration along a removal plane that is at an angle relative to a horizontal plane when support 11 is in an orientation for preparing beverage, the angle being in a range of 5 to 80 deg., such as of 15 to 75 deg., for instance of 30 to 60 deg., e.g. of 40 to 50 deg.

Ingredient opening 120 can have a or the abovementioned rim that extends in the transfer configuration along a or along the abovementioned removal plane, the rim of the ingredient opening 120 and the remover 20 being configured to move relatively to one another into and/or out of the transfer configuration without passing through the removal plane.

Seat 12 and remover 20 may be configured to relatively move into and/or out of the transfer configuration by translation along a straight direction optionally with a rotation.

Mixing unit 10 may include a closure seal 15, such as an elastically deformable seal, e.g. a silicon and/or NBR seal, which is located between closure part 13 and seat 12 when closed by seat 12 so that closure seal 15 is urged between seat 12 and closure part 13 in an urging direction that is substantially parallel to a direction of opening and/or closing seat 12 by closure part 13.

Closure seal 15 may be located along a peripheral part of ingredient opening 120, closure seal 15 being for instance an annular seal.

Closure seal 15 may be compressed along an axial direction of closure seal 15, closure seal 15 being for instance an annular seal.

Closure seal 15 may be fixed to closure part 13 or to seat 12.

Closure part 13 may include a peripheral sealing member 130, e.g. a member 130 bearing a or the abovementioned closure seal 15, displaceably mounted on a closure holder 131 and urged away from holder 131 against seat 12, e.g. by a resilient device and/or jack device, while flavouring ingredient 2 is mixed with water 3 in mixing chamber 12′.

Mixing chamber 12′ can be entirely enclosed at ingredient opening 120 by sealing member 130 and optional closure seal 15.

Closure part 13 may include a hydraulic chamber 134 for urging sealing member 130 against seat 12, such as a hydraulic chamber 134 sealed by one or more seals 132, 133 extending between sealing member 130 and closure holder 131. For instance, hydraulic chamber 134 is fluidically connected to the abovementioned liquid driver 4 for urging water 3 into hydraulic chamber 134. Mixing unit 10 can be configured to guide urged water 3 from hydraulic chamber 134 into mixing chamber 12′ e.g. via the abovementioned thermal conditioner 5.

Mixing chamber 12′ can be in fluid communication with a valve 6 configured, e.g. controlled by a or the abovementioned control unit C, to release pressure from mixing chamber 12′ when containing flavouring ingredient 2 prior to driving water 3 into mixing chamber 12′ for mixing with flavouring ingredient 2. For instance, such a pressure release may be appropriate when the volume of mixing chamber 12′ is reduced due to a relative movement of closure part 13 and wall part 14 towards each other.

Valve 6 can be assembled to or integral with seat 12, closure part 13, wall part 14, the abovementioned inlet guide 135 or the abovementioned outlet guide 140.

Valve 6 may be arranged to be open to release air from chamber 12′ when wall part 14 and closure part 13 are relatively moved together.

Valve 6 can be arranged to be closed from a beginning of introduction of water 3 into mixing chamber 12′ containing ingredient 2 to form beverage 7 and until serving thereof, for instance until completion of serving thereof.

Valve 6 or a different valve assembled to or integral with seat 12, closure part 13, wall part 14, the abovementioned inlet guide 135 or the abovementioned outlet guide 140, may be used to evacuate liquid contained therein, e.g. water that is at an improper temperature for being mixed with flavouring ingredient 2. Evacuation of such liquid (e.g. water) can be achieved prior, e.g. immediately before, mixing flavouring ingredient 2 with water 3.

Mixing unit 10 can be provided with a chamber thermal conditioner 23, 24, such as a chamber heater and/or a cooler, for conditioning at least one of seat 12, closure part 13 and wall part 14. Chamber conditioner 23, 24 can be configured to thermally condition mixing chamber 12′ prior to supplying water into mixing chamber 12′. Such chamber thermal conditioning can be carried out independently of any thermal conditioning of water 3 prior to suppling it into mixing chamber 12′.

Chamber conditioner 23, 24 can have at least one of: a radiating heater 23, e.g. an infrared heater, e.g. an infrared lamp, oriented towards, and optionally spaced apart from, at least one of seat 12, closure part 13 and wall part 14; a resistive heater 24, e.g. comprising a PTC, integral with or in direct contact with at least one of seat 12, closure part 13 and wall part 14; a cooling thermocouple integral with or in direct contact with at least one of seat 12, closure part 13 and wall part 14, and/or a heat pump in thermal conduction with at least one of seat 12, closure part 13 and wall part 14; and a temperature sensor for sensing a temperature of the abovementioned at least one of seat 12, closure part 13 and wall part 14 and controlling the conditioning of mixing chamber 12′.

Chamber conditioner 23, 24 may have a configuration for heating or cooling at least one of seat 12, closure part 13 and wall part 14 to a temperature in the range of 50 to 125% of a water temperature of water 3 subsequently supplied into mixing chamber 12′ during beverage preparation, for instance a water temperature in the range of 60 to 110° C., such as 75 to 100° C., e.g. 85 to 95° C., and/or to a temperature that is in the range of 0 to 10° C., such as 2 to 7° C., e.g. 3 to 5° C. above or below the water temperature of water 3 subsequently supplied into mixing chamber 12′ during the beverage preparation.

The chamber heater may include such radiating heater 23 that is oriented to radiate heating light, e.g. infrared light, towards the inner shape of seat 12. Seat 12 may be configured to be stationary relative to infrared heater 23 when heated thereby and/or stationary relative to support 11 in a position between the mixing chamber configuration and the transfer configuration, e.g. in a position in the range of 25 to 75% of a travel distance of seat 12 from the mixing chamber configuration to the transfer configuration.

After an introduction into the seat's ingredient opening 120 in the transfer configuration of at least one solid portion 2 of a self-supporting agglomerate of flavouring ingredient 2 and subsequent relative movement from the transfer configuration into the mixing chamber configuration and prior to serving beverage 7 via dispensing outlet 8, the abovementioned control unit C can be configured to control a preconditioning of flavouring ingredient 2 by: a portion break-up relative movement of seat 12 and closure part 13 and wall part 14, such as by controlling one or more actuators 16, 17, e.g. motors, associated therewith; and/or a portion loosening supply of water 3 from a or the abovementioned water source 3′ into mixing chamber 12′, such as by controlling a or the abovementioned liquid driver 4 and optionally a or the abovementioned thermal conditioner 5.

Flavouring ingredient 2 can be introduced into chamber's opening 120 as one or more solid portions 2, each portion having a rollable shape, e.g. a substantially spherical or ellipsoidal or cylindrical shape or a combination of parts of such shapes, with: a maximum dimension in the range of 15 to 35 mm such as 17.5 to 30 mm e.g. 20 to 27 mm; and/or a maximum dimension in the range of 10 to 90%, for instance 25 to 75% such as 40 to 65% e.g. 51 to 60%, of a maximum dimension of the base of the seat's inner shape.

Control unit C may be configured to control via the abovementioned at least one actuator 17 the break-up relative movement between wall part 14 and closure part 13 so as to exercise a compression force F onto solid portion(s) 2 between closure and wall parts 13, 14 to break-up solid portion(s) 2.

For instance, the agglomerate flavouring ingredient is selected from ground coffee, tea, cacao and chocolate, such as 4 to 12 g ground coffee e.g. 5 to 9 g ground coffee.

Control unit C and the abovementioned at least one actuator 17 can be configured such that compression force F is of at least 20 N, such as at least 30 N, for instance at least 40 N. Compression force F can be of at most 200 N, such as at most 175 N, for instance at most 150 N, e.g. at most 125 N.

Control unit C may be configured to control the break-up relative movement between wall part 14 and closure part 13 such that closure and wall parts 13, 14 are relatively moved to one another between a break-up starting spacing at which compression force F is generated and a mixing spacing at which flavouring ingredient 2 is mixed with water 3. The mixing spacing and the break-up starting spacing may have a ratio in the range of 0.1 to 0.8 such as 0.2 to 0.4.

Machine 1 can have a sensor arrangement connected to control unit C for sensing the break-up starting spacing, control unit C being configured to determine the mixing spacing from the sensed break-up starting spacing and/or from monitoring an evolution of a required compression force F when closure and wall parts 13, 14 are relatively moved to one another between the break-up starting spacing and the mixing spacing.

The sensor arrangement can be configured to determine at least one of: a power consumption of at least one actuator 17 e.g. by measuring an electric current and/or voltage consumed by such actuator(s) 17; and a volume and/or weight and/or number of portions supplied into ingredient opening 120 for a serving of beverage 7 via dispensing outlet 8.

Control unit C, to control the preconditioning of flavouring ingredient 2, may control the abovementioned liquid driver 4 and optionally the abovementioned thermal conditioner 5 e.g. for thermal conditioning to a temperature corresponding substantially to a water temperature during beverage preparation and serving of the beverage 7 via dispensing outlet 8 (e.g. a water conditioning temperature that is within 3, 5 or 10° C. of a beverage preparation temperature or a beverage serving temperature), to supply the abovementioned portion loosening supply of water 3 into mixing chamber 12′ and then to interrupt the supply of water 3 for a period of time, such as for 1 to 120 sec. for instance 5 to 60 sec. e.g. 10 to 30 sec. and/or at a pressure in chamber 12′ that is substantially constant, prior to serving beverage 7.

Control unit C can be configured to control the supply into mixing chamber 12′ of the abovementioned portion loosening supply of water 3:
after and/or before carrying out the abovementioned portion break-up relative movement of seat 12 and closure part 13 and wall part 14; and/or
in a volume that is in a range of 3 to 85%, such as 5 to 50%, e.g. 10 to 25%, of a total volume of mixing chamber 12′ at a spacing of closure and wall parts 13, 14 when the abovementioned beverage 7 is prepared and served via dispensing outlet 8; and/or
at a or the abovementioned pressure in mixing chamber 12′ that is in a range of 0.1 to 30 bar above ambient pressure, such as 0.5 to 25 bar above ambient pressure, for instance 1 to 20 bar above ambient pressure, e.g. 2.5 to 16 bar or 4 to 13 bar above ambient pressure; and/or
while closing the abovementioned outlet guide 140 with an outlet valve 142, such as: a resilient valve, e.g. a check-valve; and/or a valve controlled by control unit C, e.g. a solenoid valve and/or a pinch valve.

During operation of machine 1, flavouring ingredient 2 can be supplied into seat 12 in the transfer configuration. After seat 12 is brought into the mixing chamber configuration, ingredient 2 may be mixed with water 3 in mixing chamber 12′ to form beverage 7 that may then be served via dispensing outlet 8.

1. A machine for handling a flavouring ingredient and preparing a beverage therefrom and serving said beverage via a dispensing outlet to a consumer receptacle including a mixing unit that comprises:
a support, such as a frame and/or housing, that is stationary during said handling of said flavouring ingredient;
a seat configured to receive said flavouring ingredient unwrapped before mixing with said water;
a closure part configured to close and open the ingredient opening;
a wall part that is movable inside the seat,
the seat, the closure part and the wall part being:
directly or indirectly mounted to the support; and
relatively movable between: a transfer configuration for supplying said flavouring ingredient into the seat and/or removing such ingredient upon beverage preparation; and a mixing chamber configuration in which the seat and the closure part and the wall part form a mixing chamber fluidically connected with the water source,
during beverage preparation, said flavouring ingredient being mixed with said water in the mixing chamber to form said beverage prior to serving thereof via the dispensing outlet,
such machine comprising a control unit,
the control unit is configured to control a preconditioning of the flavouring ingredient after an introduction into the seat's ingredient opening in the transfer configuration of at least one solid portion of a self-supporting agglomerate of said flavouring ingredient and subsequent relative movement from the transfer configuration into the mixing chamber configuration and prior to serving said beverage via the dispensing outlet,
wherein said preconditioning of the flavouring ingredient comprises:
a portion loosening supply of water from a or said water source into the mixing chamber.

2. The machine of claim 1, wherein the control unit, to control the preconditioning of the flavouring ingredient, controls said liquid driver for thermal conditioning to a temperature corresponding substantially to a water temperature during beverage preparation and serving of the beverage via the dispensing outlet, to supply said portion loosening supply of water.

3. The machine of claim 1, wherein the control unit is configured to control via said at least one actuator said break-up relative movement between the wall part and the closure part so as to exercise a compression force onto the solid portion(s) between the closure and wall parts to break-up the solid portion(s).

4. The machine of claim 1, wherein the seat is configured to move relatively to the support according to simultaneous and/or successive geometric translation and geometric rotation.

5. The machine of claim 4, wherein the seat has a first pivot and a second pivot spaced apart from the first pivot, the seat being configured such that, to move from the mixing chamber configuration to the transfer configuration:
in a first step, the first and second pivots move relatively to the support along a single straight direction or along parallel directions to move out of the mixing chamber configuration; and then
in a second step, the first and second pivots move simultaneously along first and second directions.

6. The machine of claim 1, wherein the mixing unit comprises said wall part actuator that is connected to the wall part by a wall part transmission.

7. The machine of claim 1, wherein the support and the seat are connected by a guide-rail arrangement.

8. The machine of claim 1, wherein the mixing unit comprises a waste ingredient remover configured to remove a waste ingredient.

9. The machine of claim 1, wherein the mixing unit comprises a closure seal, which is located between the closure part and the seat when closed by the seat so that the closure seal is urged between the seat and the closure part in a direction that is substantially parallel to a direction of opening and/or closing the seat by the closure part.

10. The machine of claim 1, wherein the closure part comprises a peripheral sealing member.

11. The machine of claim 1, wherein the mixing chamber is in fluid communication with a valve configured to release pressure from the mixing chamber when containing said flavouring ingredient prior to driving said water into the mixing chamber for mixing with the flavouring ingredient.

12. A combination of a machine for handling a flavouring ingredient and preparing a beverage therefrom and serving said beverage via a dispensing outlet to a consumer receptacle including a mixing unit that comprises:
a support, such as a frame and/or housing, that is stationary during said handling of said flavouring ingredient;
a seat configured to receive said flavouring ingredient unwrapped before mixing with said water;
a closure part configured to close and open the ingredient opening;
a wall part that is movable inside the seat,
the seat, the closure part and the wall part being:
directly or indirectly mounted to the support; and
relatively movable between: a transfer configuration for supplying said flavouring ingredient into the seat and/or removing such ingredient upon beverage preparation; and a mixing chamber configuration in which the seat and the closure part and the wall part form a mixing chamber fluidically connected with the water source,
during beverage preparation, said flavouring ingredient being mixed with said water in the mixing chamber to form said beverage prior to serving thereof via the dispensing outlet,
such machine comprising a control unit,
the control unit is configured to control a preconditioning of the flavouring ingredient after an introduction into the seat's ingredient opening in the transfer configuration of at least one solid portion of a self-supporting agglomerate of said flavouring ingredient and subsequent relative movement from the transfer configuration into the mixing chamber configuration and prior to serving said beverage via the dispensing outlet,
wherein said preconditioning of the flavouring ingredient comprises:
a portion loosening supply of water from a or said water source into the mixing chamber and a flavouring ingredient for preparing said beverage in the machine.

13-15. (canceled)
